(19) United States
(12) Patent Application Publication
(10) Pub. No.: US 2015/0318682 A1
(43) Pub. Date: Nov. 5, 2015

(54) ARRANGEMENT FOR DETECTING ARCS IN AN ELECTRIC INSTALLATION ARRANGEMENT

(71) Applicant: EATON INDUSTRIES (AUSTRIA) GMBH, Schrems (AT)

(72) Inventor: Michael KOCH, Wien (AT)

(21) Appl. No.: 14/647,853

(22) PCT Filed: Nov. 29, 2013
(86) PCT No.: PCT/EP2013/075182

§ 371 Date: May 28, 2015

(30) Foreign Application Priority Data
Nov. 30, 2012 (DE) 10 2012 111 670.9

(51) Int. Cl. H02H 1/00; H02H 7/20

(52) U.S. Cl. CPC H02H 1/0015; H02H 1/0092; H02H 7/20

(57) ABSTRACT

An arrangement for detecting arcs in an electric installation arrangement includes at least one first sub-network and a second sub-network. At least one first detector for measuring an electric variable and outputting a first measurement signal is arranged in the first sub-network, and at least one second detector for measuring an electric variable and outputting a second measurement signal is arranged in the second sub-network. The arrangement may have an arc-detecting device, and the first detector and the second detector may be connected to the arc-detecting device so as to transmit messages.

### CROSS-REFERENCE TO RELATED APPLICATIONS

This application is a U.S. national stage application under 35 U.S.C. §371 of International Application No. PCT/EP2013/075182, filed on Nov. 29, 2013, and claims benefit to German Patent Application No. DE 10 2012 111 670.9, filed on Nov. 30, 2012. The International Application was published in German on Jun. 5, 2014, as WO 2014/083193 A1 under PCT Article 21(2).

### FIELD

The invention relates to an arrangement for detecting arcs in an electric installation arrangement according to the preamble of claim 1.

### BACKGROUND

Arranging special protective switches to protect against arcs in electric installation arrangements or other electric circuits is known. These analyze recorded measurement signals using different mathematical methods in order to detect the occurrence of an arc within the equipment concerned.

Arcs are very complex electrical occurrences. There are different types of arc, as regards their generation as well as their effects on people and equipment. For example, there are arcs which occur during proper operation of an electric device, such as the sparking of a direct current motor, but there are also those that can be traced back to a fault.

It has been shown that distinguishing between intentional and harmless arcs, which do not require any special actions such as switching off an electric network, and dangerous and unintentional arcs is very difficult and simple evaluation circuits, such as filter banks, which consist of just one or two band-pass filters and a subsequent evaluation of the amplitudes of the filtered measurement signals, are not capable of doing this. Such simple evaluation circuits therefore only ensure low protection against events caused by arcs and also cause networks to be switched off unnecessarily due to harmless arcs. While more reliable methods of showing that a measurement signal course is caused by an arc are already known today, these are complex and require a high computational cost in their implementation, which is why protective devices constructed in this way are very complex and cost intensive, and have a correspondingly low prevalence. Because of these circumstances only few people and pieces of equipment enjoy effective protection against the effects of dangerous arcs.

### SUMMARY

An aspect of the invention provides arrangement for detecting arcs in an electric installation arrangement, the arrangement comprising: an arc-detecting device, wherein the installation arrangement comprises: a first sub-network; a second sub-network; a first detector, configured to measure an electric variable and configured to output a first measurement signal, the first detector being arranged in the first sub-network; and a second detector, configured to measure an electric variable and configured to output a second measurement signal, the second detector being arranged in the second sub-network, wherein the first detector is connected to the arc-detecting device so as to transmit messages, and wherein the second detector is connected to the arc-detecting device so as to transmit messages.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic block diagram of a first preferred embodiment of an arrangement according to the invention; and

FIG. 2 is a schematic block diagram of a second preferred embodiment of an arrangement according to the invention.

### DETAILED DESCRIPTION

An aspect of the invention is therefore to provide an arrangement for detecting arcs in an electric installation arrangement of the type referred to at the beginning, with which the disadvantages referred to can be prevented and with which people and equipment can be protected from effects caused by arcs simply, cost effectively and reliably.

As a result of this, protection of people and equipment from the effects of dangerous arcs that is technically simple and cost effective to implement can be facilitated. Because a plurality of detectors is distributed across an installation arrangement, the location of an occurrence of an arc can be located effectively. Because the equipment only has one single arc-detecting device, this can be constructed correspondingly efficiently, at an outlay comparable to separate cheap arc protection switches in each sub-network, in order to analyze the signals generated by the individual detectors according to reliable methods and algorithms. As a result, the number of network switch-offs that are unnecessary in terms of safety can be reduced and nevertheless improved protection against effects caused by arcs can be achieved.

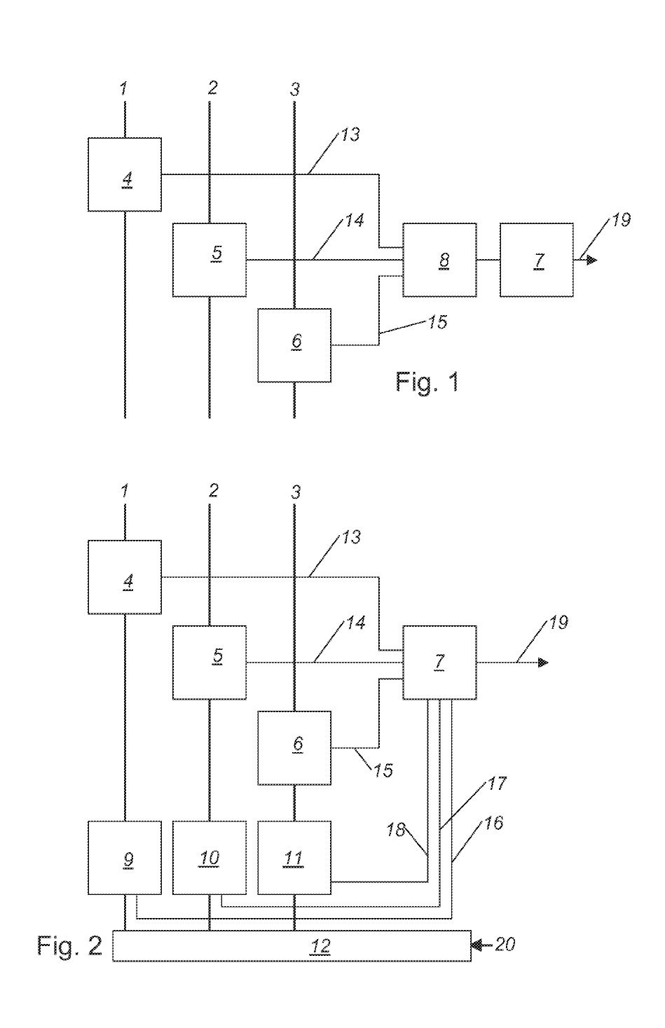

FIGS. 1 and 2 show arrangements for detecting arcs and electrical effects caused by arcs in an electric installation arrangement, the installation arrangement having at least one first sub-network 1 and a second sub-network 2, at least one detector 4 for measuring an electric variable and outputting a first measurement signal being arranged in the first sub-network 1, at least one second detector 5 for measuring an electric variable and outputting a second measurement signal being arranged in the second sub-network 2, the arrangement having an arc-detecting device 7, the first detector 4 being connected to the arc-detecting device 7 so as to transmit messages and the second detector 5 being connected to the arc-detecting device 7 so as to transmit messages.

As a result of this, protection of people and equipment from the effects of dangerous arcs that is technically simple and cost effective to implement can be facilitated. Because a plurality of detectors 4, 5, 6 is distributed across an installation arrangement, the location of the occurrence of an arc can be located effectively. Because the equipment only has one single arc-detecting device 7, this can be constructed correspondingly efficiently, at an outlay comparable to separate cheap arc protection switches in each sub-network, in order to analyze the signals generated by the individual detectors 4, 5, 6 according to reliable methods and algorithms. As a result, the number of network switch-offs that are unnecessary in terms of safety can be reduced and nevertheless improved protection against effects caused by arcs can be achieved.

An arrangement for detecting arcs in an electric installation arrangement is understood to be equipment which consists of a plurality of devices, which are arranged in an electric installation arrangement and which monitor the electric installation equipment for the occurrence of arcs and electrical effects which may be traced back to arcs. In the process, a distinction should be made in particular between harmless or intentional arcs during operation and dangerous arcs or arcs that allow for the detection of a fault inside the electric installation arrangement.

An electrical installation arrangement is preferably to be understood as the whole of the electric lines, spurs, outlets and distributors inside a building or building complex. In the process, an electric installation arrangement has at least one first sub-network 1 and a second sub-network 2. FIGS. 1 and 2 each show electric installation arrangements, which additionally have a third sub-network 3. The invention is described hereinafter with respect to FIGS. 1 and 2 with three sub-networks, it of course also being possible for there to be a larger number of sub-networks 1, 2, 3.

The individual sub-networks 1, 2, 3 are each shown in FIGS. 1 and 2 as individual thicker black lines, which each illustrate the whole of the existing electric lines per sub-network 1, 2, 3.

It is preferably provided for the first, the second and/or the third sub-network 1, 2, 3 to be connected to an electric distributor 12, or to branch off from such a distributor 12. In particular, a distributor 12 is to be understood to be a distribution cabinet, which is also called a fuse box colloquially, and in which the protective switches 9, 10, 11 of an electric installation arrangement are also arranged. FIG. 2 shows an electric installation arrangement, in which the first sub-network 1 is connected by means of a first protective switch 9 to the distributor 12, the second sub-network 2 is connected by means of a second protective switch 10 to the distributor 12 and the third sub-network 3 is connected by means of a third protective switch 11 to the distributor 12. In the process, the distributor 12 connects the individual sub-networks 1, 2, 3 to a supply line 20 of a superordinate electric network.

It is provided for at least one first detector 4 for measuring an electric variable and outputting a first measurement signal to be arranged in the first sub-network 1, at least one second detector 5 for measuring an electric variable and outputting a second measurement signal being arranged in the second sub-network 2.

In the process, it is preferably provided for at least one corresponding detector 4, 5, 6 to be arranged respectively in each of the sub-networks 1, 2, 3 of an electric installation arrangement, it also being possibly provided for only certain sub-networks 1, 2, 3 of an electric installation arrangement to be equipped accordingly.

The individual detectors 4, 5, 6 are preferably constructed identically. These are provided to measure an electric variable within the sub-network concerned and to output a progression of measurement values or a measurement signal. It is preferably provided for the first detector 4 and/or the second detector 5 and/or the third detector 6 to each have a sensor, which is constructed in particular as a current and/or voltage sensor.

Furthermore, the detectors 4, 5, 6 preferably have an amplifier which amplifies the signals generated by the sensors, as well as a detector output which is connected to an output of the amplifier. It can also be provided for a detector 4, 5, 6 to have a plurality of sensors. The construction of a sensor as a current sensor and/or voltage sensor is known per se. In the process, the construction of the sensor as a current transformer can lead to the detector 4, 5, 6 concerned being physically arranged around lines of a sub-network 1, 2, 3, without itself therefore being electrically integrated in the sub-network 1, 2, 3.

It can be provided for the individual detectors 4, 5, 6 to be arranged at any chosen location inside the electric installation arrangement or in the individual sub-networks 1, 2, 3. It is preferably provided for the first detector 4 and/or the second detector 5 and/or the third detector 6 to be arranged in the region of an electric output. “In the region of an electric output” in this context means in particular in a portion of the sub-network 1, 2, 3 concerned between the last spur of another portion and an electric output, which is designed in particular as a socket, or as a directly connected load. As a result of this, it is possible for the measurement signals received and output by the detector to substantially only be controlled by the load connected to the outlet concerned, as a result of which good locatability of an arc is facilitated. Moreover, disruptive electrical interference from other loads can be reduced as a result. As a development of the present measures, it is therefore preferably provided for it to be possible also for a plurality of detectors 4, 5, 6 to be arranged in a sub-network 1, 2, 3, in particular for at least one detector 4, 5, 6 each to be arranged in the region of each electric output of a sub-network 1, 2, 3.

It is provided for the arrangement to have an arc-detecting device 7, for the first detector 4 to be connected to the arc-detecting device 7 so as to transmit messages, for the second detector 5 to be connected to the arc-detecting device 7 so as to transmit messages and for the third detector 6, which is preferably provided, to be connected to the arc-detecting device 7 so as to transmit messages.

In the process, any connection between electric or electronic devices which allows a transmission of information between these devices is regarded as being connected so as to transmit messages or as a connection for transmitting messages 13, 14, 15.

In particular, it is provided in the process for the individual detectors 4, 5, 6 to be connected to the arc-detecting device 7 so as to transmit messages by means of a wire-bound message transmitting connection 13, 14, 15 or by means of radio communication. According to FIGS. 1 and 2, it is provided for the first detector 4 to be connected to the arc-detecting device 7 so as to transmit messages by means of a first message transmitting connection 13, for the second detector 5 to be connected to the arc-detecting device so as to transmit messages by means of a second message transmitting connection 14, and for the third detector 6 to be connected to the arc-detecting device so as to transmit messages by means of a third message transmitting connection 15.

It can be provided, as shown in FIG. 2, for the individual detectors 4, 5, 6 to be connected at different inlets of the arc-detecting device 7, or also, as shown in FIG. 1, for the first detector 4, the second detector 5 and the preferably provided third detector 6 to be connected to a multiplexer 8 so as to transmit messages, said multiplexer 8 being connected to the arc-detecting device 7 so as to transmit messages.

The arc-detecting device 7 is a device, which is provided and configured to analyse incoming measurement signals of electric variables, such as in particular current courses and/or voltage courses by means of mathematical methods and to detect whether these measurement signals were caused by an arc. Arcs cause disruptions in electric systems which often differ from disruptions caused in other ways. However, due to the diversity of different arcs, usually only very complex and usually also very computationally intensive methods facilitate a good assignment of a measurement signal to a certain arc cause or arc effect in the process. By using just one single arc-detecting device 7 in the whole installation arrangement, this can be equipped with high quality and usually also costly components, as a result of which it is capable of applying modern algorithms for arc detection. Appropriate algorithms, which in particular use transformation methods such as the wavelet transformation, have been described in literature in the meantime.

The arc-detecting device 7 preferably has at least one date processing unit, which is designed to analyze the measurement signals transmitted by the first detector 4 and/or the second detector 5 and/or the third detector 6 to the arc-detecting device 7 according to at least one settable method for showing an arc in the first sub-network 1 and/or the second sub-network 2 and/or the third sub-network 3.

The data processing unit is designed in particular as a microcomputer, comprising at least one microcontroller and at least one memory module. It can also be provided for the arc-detecting device 7 to have a DSP or an FPGA which is designed and programmed accordingly. In particular by using stored program components, like an FPGA, the arc-detecting device 7 can be implemented as a full hardware solution.

The data processing unit is designed, by means of a hardware design and/or by appropriate programming, to carry out at least one appropriate method or an algorithm for arc detection or assignment.

Furthermore, the arc-detecting device 7 preferably has a power supply unit as well as connection points for the detectors 4, 5, 6 or a multiplexer 8. Furthermore, said device preferably has a control and/or monitoring outlet 19 in order to communicate with additional assemblies such as a building management system and for service work and/or software updates.

Furthermore, it is preferably provided, and as shown in FIG. 2, for the arc-detecting device 7 to be connected to the first protective switch 9 and/or with the second protective switch 10 and/or with the third protective switch at least indirectly in each case for the settable triggering of the first protective switch 9 and/or of the second protective switch 10 and/or of the third protective switch 11. As a result of this, when a measurement signal is reported as being caused by an arc, it is possible in a simple manner to disconnect the sub-network 1, 2, 3 concerned or to isolate it from the remaining installation arrangement using the arc-detecting device 7.

In the process it is provided in particular for the individual protective switches 9, 10, 11 to be designed as protective switches 9, 10, 11 with an electric trigger input; it can, however, also be provided for each of the protective switches 9, 10, 11 to be assigned to an external trigger, which accesses the mechanical trigger sockets, as many of these protective switches 9, 10, 11 have, in order to trigger the protective switches 9, 10, 11 in a settable manner. It can also be provided for a device, which is controlled by the arc-detecting device 7, to be arranged in at least one of the sub-networks 1, 2, 3 in order to bring about an electric condition in the sub-network 1, 2, 3 concerned which leads to the protective switch 9, 10, 11 of the sub-network concerned being triggered, for example excess current or residual current.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. An arrangement for detecting arcs in an electric installation arrangement, the arrangement comprising:
an arc-detecting device,
wherein the installation arrangement comprises:
a first sub-network;
a second sub-network;
a first detector, configured to measure an electric variable and configured to output a first measurement signal, the first detector being arranged in the first sub-network; and
a second detector, configured to measure an electric variable and configured to output a second measurement signal, the second detector being arranged in the second sub-network,
wherein the first detector is connected to the arc-detecting device so as to transmit messages, and
wherein the second detector is connected to the arc-detecting device so as to transmit messages.

2. The arrangement of claim 1, wherein the first detector and/or the second detector is arranged in the region of an electric outlet.

3. The arrangement of claim 1, wherein the first detector and/or the second detector is connected to a multiplexer so as to transmit messages,
wherein the multiplexer is connected to the arc-detecting device so as to transmit messages.

4. The arrangement of claim 1, wherein the first detector and/or the second detector each includes:
a sensor;
an amplifier, which is connected to the sensor; and
a detector output connected to the amplifier.

5. The arrangement of claim 1, wherein the arc-detecting device has a data processing unit, which is designed to analyze the measurement signals transmitted by the first detector and/or the second detector to the arc-detecting device according to at least one settable method for showing an arc in the first sub-network and/or the second sub-network.

6. The arrangement of claim 1, wherein the first sub-network is connected to a distributor of the installation arrangement by a first protective switch,
wherein the second sub-network is connected to the distributor by a second protective switch, and
wherein the arc-detecting device is connected to the first protective switch and/or to the second protective switch at least indirectly for the settable triggering of the first protective switch and/or to the second protective switch.

7. The arrangement of claim 4, wherein the sensor includes a current sensor, a voltage sensor, or both.
